(19) United States
(12) Patent Application Publication
(10) Pub. No.: US 2026/0235563 A1
(43) Pub. Date: Aug. 13, 2026

(54) METHOD FOR ANALYZING ORAL CARE COMPOSITION

(71) Applicant: SHIMADZU CORPORATION, Kyoto-shi, Kyoto (JP)

(72) Inventor: Natsuki IWATA, Kyoto-shi, Kyoto (JP)

(73) Assignee: SHIMADZU CORPORATION, Kyoto-shi, Kyoto (JP)

(21) Appl. No.: 19/153,764

(22) PCT Filed: Nov. 9, 2023
(86) PCT No.: PCT/JP2023/040360

§ 371 Date: Oct. 8, 2025

(30) Foreign Application Priority Data
Feb. 21, 2023 (JP) 2023-025474

(51) Int. Cl. G01N 30/74; B01D 15/08; B01D 15/42; B01J 20/22; B01J 20/28; B01J 20/286; G01N 30/02; G01N 30/86

(52) U.S. Cl. CPC G01N 30/74; B01D 15/08; B01D 15/424; B01J 20/22; B01J 20/28004; B01J 20/28061; B01J 20/28083; B01J 20/286; G01N 30/8624; G01N 2030/027

(57) ABSTRACT

The present disclosure provides a method of detecting active ingredients in a sample solution containing an oral care composition.

### TECHNICAL FIELD

The present invention relates to a method for analyzing an oral care composition.

### BACKGROUND ART

Conventionally, oral care products (oral care compositions) such as mouthwashes, toothpastes, gargles, and cough drops contain various active ingredients to clean the oral cavity. Among these active ingredients, cetylpyridinium chloride (CPC) and dipotassium glycyrrhizinate (GK2) have recently attracted attention from the viewpoint of having high bactericidal or anti-inflammatory effects, and the need for analysis of these substances is expected to increase.

However, since CPC is a basic substance, it is not retained and separated by the stationary phase in a column in reversed-phase chromatography, which is a general analytical method. Therefore, it is known to be analyzed by reversed-phase ion-pair chromatography in which an ion-pair reagent is added to the mobile phase. For example, Non-Patent Literature 1 reports the analysis of CPC and GK2 by adding sodium perchlorate (NaClO₄) as an ion-pair reagent to the mobile phase.

### PRIOR ART DOCUMENTS

### Non-Patent Literature

[Non-Patent Literature 1] GL sciences, “InertSustain For LC, Analysis of Crude Drugs Data No. LA677-0811”, https://www.glsciences.com/viewfile/?p=LA677, [retrieved on Feb. 13, 2023], Internet

### SUMMARY OF INVENTION

### Technical Problem

However, the method of Non-Patent Literature 1 requires a conditioning time to modify the stationary phase (particularly, the functional groups chemically bonded to the packing material) with the ion-pair reagent. Since the conditioning time is approximately 2 to 3 hours, a long time is required for preparation before the start of analysis. In addition, this method is not highly compatible with the gradient elution method, which completes the analysis in a short time by changing the solvent ratio of the mobile phase during the analysis. Therefore, it is necessary to perform the analysis with the isocratic elution method in which the solvent ratio of the mobile phase is kept constant, which also requires a long time for the analysis itself, such as the elution time. Specifically, the elution of CPC alone requires 10 minutes or more.

Furthermore, recently, isopropyl-3-methylphenol (IPMP; 4-Isopropyl-3-Methylphenol) has also come to be included in oral care products as an active ingredient with a high bactericidal effect, and it is anticipated that it will be necessary to detect this component simultaneously. However, since IPMP is a neutral component, it is not known whether it can be separated from the above two components when measured by liquid chromatography.

Accordingly, an object of the present invention is to provide a method that can simply and rapidly analyze cetylpyridinium chloride (CPC), dipotassium glycyrrhizinate (GK2), and isopropyl-3-methylphenol (IPMP), which are active ingredients of an oral care composition, all at once.

### Solution to Problem

An analytical method of a first aspect of the present invention is an analytical method for detecting active ingredients by performing liquid chromatography on a sample solution containing an oral care composition, the method comprising: passing the sample solution through a column using an acidic mobile phase, and then simultaneously detecting cetylpyridinium chloride, dipotassium glycyrrhizinate, and isopropyl-3-methylphenol in the sample solution that has passed through, using an absorbance detector.

### Advantageous Effects of Invention

According to the analytical method of the first aspect, cetylpyridinium chloride (CPC), dipotassium glycyrrhizinate (GK2), and isopropyl-3-methylphenol (IPMP), which are active ingredients of an oral care composition, can be analyzed simply and rapidly all at once.

### BRIEF DESCRIPTION OF DRAWINGS

FIG. 1 is a chromatogram of a sample solution and a mixed standard solution under the condition of a wavelength of 250 nm in Example 1, where the vertical axis represents peak intensity and the horizontal axis represents retention time.

FIG. 2 is a chromatogram of the sample solution and the mixed standard solution under the condition of a wavelength of 258 nm in Example 1.

FIG. 3 is a chromatogram of the sample solution and the mixed standard solution under the condition of a wavelength of 280 nm in Example 1.

FIG. 4 is a graph combining the UV spectrum of peak “1” of the sample solution and the UV spectrum of an individual standard solution of CPC, where the vertical axis represents peak intensity and the horizontal axis represents wavelength.

FIG. 5 is a graph combining the UV spectrum of peak “2” of the sample solution and the UV spectrum of an individual standard solution of GK2.

FIG. 6 is a graph combining the UV spectrum of peak “3” of the sample solution and the UV spectrum of an individual standard solution of IPMP.

### DESCRIPTION OF EMBODIMENTS

### 1. First Embodiment

The analytical method of the first embodiment of the present invention performs liquid chromatography on a sample solution.

The sample solution is an oral care composition, and examples thereof include oral care products such as mouthwashes, toothpastes, gargles, and cough drops. The sample solution may be diluted with an organic solvent such as methanol, water, or the like, as necessary. When a diluted solution of the oral care composition is used as the sample solution, the dilution factor may be, for example, 2 times or more, preferably 5 times or more, and for example, 1000 times or less, preferably 500 times or less. This allows for high-sensitivity detection of the active ingredients while suppressing contamination of the column and other apparatuses.

In liquid chromatography, the sample solution is mixed with a mobile phase (eluent) and passed through a column, thereby separating the components in the sample solution over time. As an apparatus used for liquid chromatography, a known liquid chromatograph may be used, and for example, the Nexera series manufactured by Shimadzu Corporation is commercially available.

An acidic mobile phase is used as the mobile phase. Examples of such an acidic mobile phase include a phosphate buffer, a citrate buffer, an acetate buffer, and a formate buffer, with a phosphate buffer being preferable. The pH of the acidic mobile phase is, for example, 1 or more and 3 or less. Further, it is preferable that the acidic mobile phase further contains an organic solvent. Examples of such an organic solvent include acetonitrile, methanol, ethanol, 2-propanol, acetone, chloroform, and tetrahydrofuran, with methanol being preferable. When an organic solvent is included, the proportion of the organic solvent in the acidic mobile phase is, for example, 10 (v/v) % or more, preferably 50 (v/v) % or more, and for example, 90 (v/v) % or less, preferably 80 (v/v) % or less. As the mobile phase of the first embodiment, a mixed solvent of a phosphate buffer and methanol is preferable. This makes it possible to shift the retention times of the respective components CPC, GK2, and IPMP, thereby allowing the respective peaks to be separated even more reliably. In addition, since the absorption of light by the phosphate-based mobile phase can be suppressed during detection by the absorbance detector, detection can be performed with high sensitivity.

Further, in the first embodiment, the gradient elution method is preferably adopted. That is, the concentration of the organic solvent in the mobile phase is gradually increased from the initial stage of the analysis. This makes it possible to shorten the analysis completion time while maintaining good peak separation for each component.

The column equipped in the liquid chromatograph is preferably packed with octadecyl groups chemically bonded to silica particles. That is, the sample solution is passed through a column packed with octadecyl groups chemically bonded to silica particles.

This makes it possible to further shift the retention times of the respective components CPC, GK2, and IPMP, thereby improving peak separation.

The average particle size of the silica gel is, for example, 0.1 μm or more, preferably 1 μm or more, more preferably 2 μm or more, and for example, 20 μm or less, preferably 10 μm or less, more preferably 5 μm or less. The pore size is, for example, 1 nm or more, preferably 5 nm or more, more preferably 11 nm or more, and for example, 50 nm or less, preferably 30 nm or less, more preferably 20 nm or less. The surface area is, for example, 100 m²/g or more, preferably 300 m²/g or more, more preferably 320 m²/g or more, and for example, 500 m²/g or less, preferably 400 m²/g or less, more preferably 345 m²/g or less. The carbon content is, for example, 5% or more, preferably 10% or more, more preferably 15% or more, and for example, 30% or less, preferably 20% or less, more preferably 18% or less. These are measured, for example, in accordance with the silica gel test method (JIS K1150-1994). They can also be measured using an automatic specific surface area and pore distribution measuring device (TriStar II (registered trademark), manufactured by Shimadzu Corporation) or the like. Further, the silica gel may be subjected to end-capping treatment or the like. A specific example of a column containing such a packing material is Shim-pack Arata C18 manufactured by Shimadzu Corporation. By using such a column, tailing of the peaks of the respective components CPC, GK2, and IPMP can be suppressed, and peak separation can be further improved.

The column temperature is, for example, 10° C. or higher, preferably 40° C. or higher, and for example, 60° C. or lower, preferably 50° C. or lower. By setting the temperature within the above range, peak separation becomes favorable.

As the detector, an absorbance detector, specifically, a UV-Vis absorbance detector is used, and preferably, a photodiode array (semiconductor element) UV-Vis absorbance detector (hereinafter, abbreviated as “PDA detector”) is used. That is, the sample solution that has passed through the column (in other words, the separated liquid in which each component of the sample solution flows out separated over time) is detected by the PDA detector. Specifically, the sample solution in a flow cell is irradiated with predetermined light (for example, mixed light of a tungsten lamp and a D2 lamp), and the transmitted light is dispersed by a diffraction grating, and light of each wavelength is detected by the PDA detector. Then, by analyzing or processing the detected light, a graph showing the light intensity (particularly, the absorbance of the separated liquid) according to the retention time is output as a chromatogram. This chromatogram is obtained for each of a plurality of wavelengths arbitrarily set by the PDA detector. In addition, since a UV spectrum (such as an absorption spectrum) for the separated liquid at a specific retention time can be obtained, a UV spectrum can be obtained for each separated component. That is, by using the PDA detector, chromatograms for a plurality of wavelengths can be obtained, and a UV spectrum for each separated component can also be obtained.

The detection wavelength is, for example, 240 nm or more and 290 nm or less. Preferably, two or more wavelengths, and more preferably three wavelengths, are used in this range. Specifically, for example, a wavelength of 245 nm or more and less than 255 nm (first wavelength), a wavelength of 255 nm or more and less than 270 nm (second wavelength), and a wavelength of 270 nm or more and 290 nm or less (third wavelength) are used. Since the UV spectrum of GK2 has a peak in the first wavelength region, the UV spectrum of CPC has a peak in the second wavelength region, and the UV spectrum of IPMP has a peak in the third wavelength region, that is, since the above three components each absorb light particularly strongly in the first to third wavelengths, the spectroscopic analysis of the above three components can be performed more reliably.

In the chromatogram obtained by this step, peaks corresponding to each of CPC, GK2, and IPMP are confirmed in different retention time regions. In particular, the peaks of the above three components are confirmed in a short time of 2 minutes or more and 4 minutes or less of retention time.

In the first embodiment, quantitative analysis of the active ingredients becomes possible by creating a calibration curve. Specifically, for each active ingredient, a plurality of standard solutions with known concentrations are prepared, the above detection step is performed, and chromatograms for the plurality of concentrations are obtained, thereby creating a calibration curve (a graph plotting the relationship between peak intensity and known concentration) for each component. By correlating the peak intensity of the active ingredient in the sample solution of unknown concentration with this calibration curve, the concentration of the active ingredient can be determined. In the first embodiment, since the linearity of the graph of the calibration curve is very good, the concentration of the active ingredient can be measured with excellent accuracy.

Further, in the first embodiment, identification of the active ingredients becomes possible by outputting an absorption spectrum such as a UV spectrum. Specifically, a UV spectrum is acquired for a specific peak of the chromatogram, and this UV spectrum is compared with the UV spectrum of a known active ingredient. This makes it possible to reliably determine whether a specific peak in the chromatogram is a peak due to the target active ingredient. This is effective when the sample solution contains many impurities and peaks of many impurities are detected in the chromatogram, for accurately identifying the target active ingredient.

According to the analytical method of the first embodiment, the active ingredients of the oral care composition, CPC, GK2, and IPMP, can be simultaneously separated, detected, and quantified from a sample solution. In addition, since each component can be analyzed simultaneously by a single liquid chromatography run using one column, that is, there is no need to change columns, the method is simple. Further, since it is not necessary to use an ion-pair reagent or the like and a long conditioning time is not required, and also because the retention times of the three components during analysis are short, the analysis can be performed very rapidly and simply. Furthermore, since there is no denaturation of the stationary phase by the ion-pair reagent, the column can be reused. In addition, in the obtained chromatogram, tailing of the peaks can be suppressed, and the reproducibility of the retention time and peak area is good, so the accuracy in analysis is good. Moreover, since a calibration curve with high linearity and little variation can be created, the concentration of the active ingredients can be measured accurately.

### 2. Aspects

Those skilled in the art will understand that the exemplary embodiments described above are specific examples of the following aspects.

(Item 1) An analytical method for an oral care composition according to one aspect may be an analytical method for detecting active ingredients by performing liquid chromatography on a sample solution containing an oral care composition, the method comprising:
passing the sample solution through a column using an acidic mobile phase, and then simultaneously detecting cetylpyridinium chloride, dipotassium glycyrrhizinate, and isopropyl-3-methylphenol in the sample solution that has passed through, using an absorbance detector.

(Item 2) In the analytical method according to item 1, the column may be packed with octadecyl groups chemically bonded to silica particles.

(Item 3) In the analytical method according to item 2, the silica gel may have an average particle size of 1 μm or more and 10 μm or less, the silica gel may have a pore size of 5 nm or more and 30 nm or less, and the silica gel may have a surface area of 300 m²/g or more and 400 m²/g or less.

(Item 4) In the analytical method according to any one of items 1 to 3, a wavelength of light for detecting the active ingredients with the absorbance detector may be 240 nm or more and 290 nm or less.

(Item 5) In the analytical method according to any one of items 1 to 4, the acidic mobile phase may contain a phosphate buffer and methanol.

### EXAMPLES

Next, the present invention will be described in detail with reference to examples, but the scope of the present invention is not limited by these.

### Example 1

### (Analysis of Sample Solution)

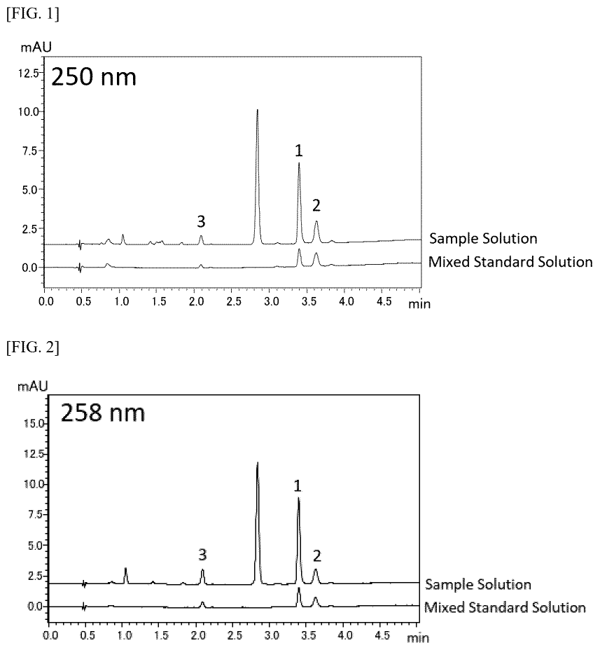

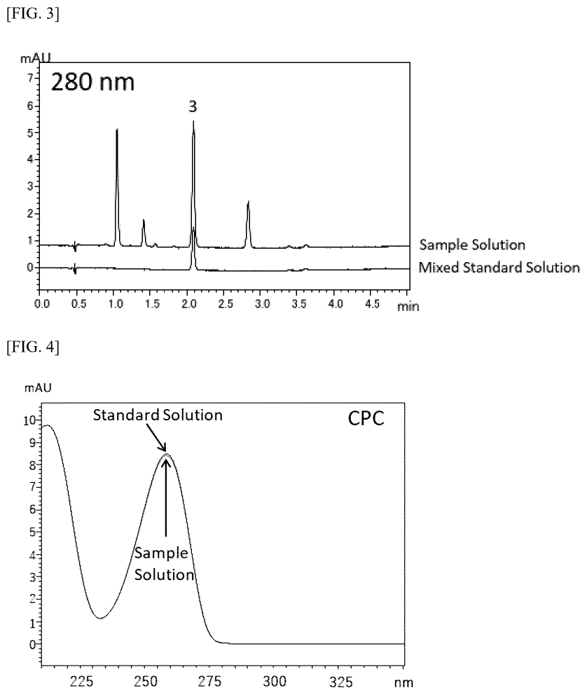

A quasi-drug (Mondamin (registered trademark) NEXT Periodontal Care) was diluted 100-fold with a 50 (v/v) % aqueous methanol solution to prepare a sample solution. In addition, a mixed standard solution containing 1 mg/L each of cetylpyridinium chloride (CPC), dipotassium glycyrrhizinate (GK2), and isopropyl-3-methylphenol (IPMP) was prepared. Liquid chromatography was performed on each of the sample solution and the mixed standard solution under the following conditions. As the mobile phase, a mixed solvent of a 20 mmol/L sodium phosphate buffer as an acidic mobile phase and methanol was used. The column was packed with octadecyl groups chemically bonded to silica particles, and the performance of this packing material is shown below. Regarding these results, a chromatogram at a detection wavelength of 250 nm is shown in FIG. 1, a chromatogram at a detection wavelength of 258 nm is shown in FIG. 2, and a chromatogram at a detection wavelength of 280 nm is shown in FIG. 3.

### <Liquid Chromatography Conditions>

Apparatus: Nexera XR (Ultra High Performance Liquid Chromatograph, manufactured by Shimadzu Corporation)
Column: Shim-pack Arata C18 (75 mm×3.0 mm I.D., 2.2 μm)
Mobile Phase: A) 20 mmol/L (Sodium) Phosphate Buffer (pH 2.6)

### B) Methanol

### Gradient Elution:

60% B (0 min), 80% B (4.00-4.50 min), 60% B (4.51-7.00 min)
Flow Rate: 0.8 mL/min
Mixer: 180 μL
Column Temperature: 45° C.
Injection Volume: 5 μL
Detector: Photodiode Array UV-Vis Absorbance Detector (“SPD-M40”, manufactured by Shimadzu Corporation)
Detection Wavelengths: 250 nm, 258 nm, 280 nm

### <Packing Material>

Base Material: Totally porous spherical high-purity silica gel
Particle Size: 2.2 μm
Pore Size: 12 nm
Surface Modification: Octadecyl group
Surface Treatment: End-capping treatment
Carbon Content: 17%
Surface Area: 340 m²/g

In FIG. 1 and FIG. 2, peaks of the three active ingredients (CPC, GK2, IPMP) were observed, and it was possible to separate and detect them. In FIG. 3, the peak of IPMP was observed, and it was possible to detect IPMP. Also, since the retention times of the three components were within 4 minutes, it was found that the simultaneous analysis could be completed in a very short time.

### (Confirmation of the Three-Component Peaks by UV Spectrum)

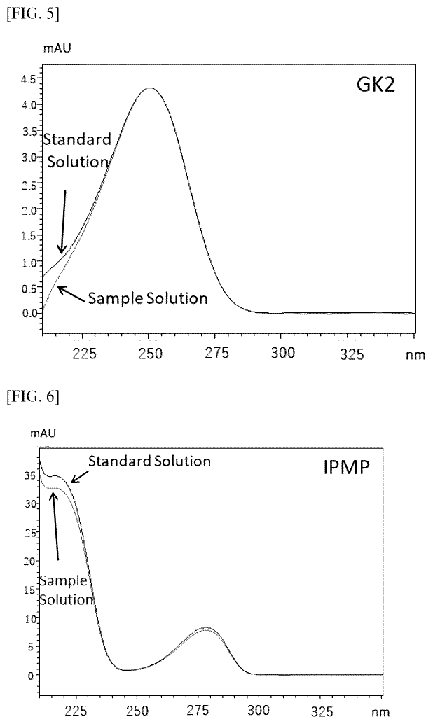

In the analysis of Example 1 above, the UV absorption spectra were measured for the peaks derived from CPC, GK2, and IPMP, namely, peaks “1”, “2”, and “3”. The results are shown in FIGS. 4 to 6. In addition, individual standard solutions containing 5 mg/L each of CPC, GK2, and IPMP were prepared. The UV absorption spectrum was measured for each of these individual standard solutions in the same manner as above, and the results are shown in FIGS. 4 to 6. As is clear from these figures, since the UV spectrum of each peak of the sample solution matched the UV spectrum of the individual standard solution, it was confirmed that peak “1” was derived from CPC, peak “2” was derived from GK2, and peak “3” was derived from IPMP.

### (Reproducibility of Retention Time)

A mixed standard solution containing 0.5 mg/L each of the three components was prepared, and the same analysis as above was repeated 6 times for this mixed standard solution. At this time, the relative relative standard deviation (RSD) of the retention time and peak area of each peak was calculated. The results are shown in Table 1 below.

TABLE 1

| | Relative standard | Relative standard |
|---|---|---|
| Active | deviation of | deviation of Peak |
| Ingredient | Retention Time (%) | Area (%) |
| CPC | 0.12 | 0.48 |
| GK2 | 0.11 | 1.01 |
| IPMP | 0.12 | 0.64 |

Regarding the retention time, the relative standard deviation for all three components was about 0.1%, and regarding the peak area, the relative standard deviation for all three components was 1.0% or less. From this, it was found that both the retention time and the peak area had very low variation and were excellent in reproducibility.

### (Confirmation of Calibration Curve)

For each of the three components, individual standard solutions with different concentrations were prepared, the same analysis as above was performed, and a calibration curve in the concentration range of 0.1 to 10 mg/L was created. At this time, the coefficient of determination (r²) for all three components was 0.999. This showed that excellent linearity was obtained, and it was found that it could be effectively used as a calibration curve.

### Reference Example 1

When the same procedure as in Example 1 was carried out by changing the column to another column (Shim-pack GIST C18 (manufactured by Shimadzu Corporation)), problems such as tailing of the CPC peak occurred.

1. A method of detecting active ingredients in a sample solution containing an oral care composition, the method comprising
passing the sample solution through a column using an acidic mobile phase containing a phosphate buffer and methanol; and then
simultaneously detecting cetylpyridinium chloride, dipotassium glycyrrhizinate, and isopropyl-3-methylphenol in the sample solution that has passed through, using an absorbance detector, wherein a wavelength of light for detecting the active ingredients with the absorbance detector is 240 nm or more and 290 nm or less.

2. The method according to claim 1, wherein the column is packed with octadecyl groups chemically bonded to silica particles.

3. The method according to claim 2, wherein
the silica gel has an average particle size of 1 μm or more and 10 μm or less,
the silica gel has a pore size of 5 nm or more and 30 nm or less, and
the silica gel has a surface area of 300 m²/g or more and 400 m²/g or less.

4. (canceled)

5. (canceled)
